(19) United States
(12) Patent Application Publication
(10) Pub. No.: US 2026/0115984 A1
(43) Pub. Date: Apr. 30, 2026

(54) INJECTION FORMING EQUIPMENT

(71) Applicant: Quanta Computer Inc., Taoyuan City (TW)

(72) Inventor: Chiu-Ching HUANG, Taoyuan City (TW)

(73) Assignee: Quanta Computer Inc., Taoyuan City (TW)

(21) Appl. No.: 19/015,913

(22) Filed: Jan. 10, 2025

(30) Foreign Application Priority Data
Oct. 30, 2024 (TW) 113141676

(51) Int. Cl. B29C 45/73

(52) U.S. Cl. CPC B29C 45/7312

(57) ABSTRACT

An injection forming equipment includes an injection forming mold, a heating module and a condensing module. The injection forming mold includes a first mold die, a second mold die, a mesh mold core. The second mold die is removably shut the first mold die and the mesh mold core to jointly define a molding cavity therebetween. The mesh mold core includes an insert body removably mounted on the first mold die, a flow channel structure formed in the insert body, and a column-distribution structure located on one surface of the insert body. The heating module is located within the mesh mold core for heating the insert body. The condensing module is connected to the flow channel structure to introduce condensed fluid into the flow channel structure for cooling the insert body down.

### CROSS-REFERENCE TO RELATED APPLICATION

This application claims priority to Taiwanese Application Serial Number 113141676, filed Oct. 30, 2024, which are herein incorporated by reference.

### BACKGROUND

### Field of Invention

The present disclosure relates to a forming equipment. More particularly, the present disclosure relates to an injection forming equipment having a mesh making mold.

### Description of Related Art

Generally, when making plastic finished products, the manufacturer thereof usually injects melting plastic into a molding cavity of a mold having dense convex columns densely arranged within the molding cavity so that dense vent holes matching the convex columns will be formed on a plastic finished product after the plastic product is formed within the molding cavity.

However, when a plastic product with larger volume and denser vent holes is desired to be produced, plastic materials in the molten state cannot be effectively filled in the partial area (e.g., convex columns) of the molding cavity if only relying on the high-pressure plastic injecting towards the molding cavity through the injection channel. In this regard, the manufacturer can only use rapid temperature control equipment to overcome the above inconveniences and defects. This not only high costs are required, but also the processing efficiency of the rapid temperature control equipment are needed to be improved urgently.

Thus, the above-mentioned technology obviously still has inconveniences and defects, which are issues that the industry needs to solve urgently.

### SUMMARY

One aspect of the present disclosure is to provide an injection forming equipment for solving the difficulties mentioned above in the prior art.

In one embodiment of the present disclosure, an injection forming equipment includes an injection forming mold, a heating module and a condensing module. The injection forming mold includes a first mold die, a second mold die and a mesh mold core. The second mold die is removably shut the first mold die and the mesh mold core to jointly define a molding cavity therebetween. The mesh mold core includes an insert body removably mounted on the first mold die, a flow channel structure formed in the insert body, and a column-distribution structure located on one surface of the insert body. The heating module is located within the mesh mold core for heating the insert body. The condensing module is connected to the flow channel structure to introduce condensed fluid into the flow channel structure for cooling the insert body down.

In one embodiment of the present disclosure, an injection forming equipment includes an injection forming mold, a heating module and a condensing module. The injection forming mold includes a first mold die, a second mold die, a mesh mold core. The second mold die is removably shut the first mold die and the mesh mold core to jointly define a molding cavity therebetween. The mesh mold core includes an insert body removably mounted on the first mold die, a flow channel structure formed in the insert body, and a column-distribution structure located on one surface of the insert body. The heating module is located within the mesh mold core for heating the insert body. The condensing module includes a case, a control valve, at least one vortex tube and at least one air supply pipe. The vortex tube is disposed within the case for spraying condensed fluid, the control valve is located in the case and connected to the vortex tube for controlling the timing of the condensed fluid of the vortex tube being sent into the flow channel structure, and the air supply pipe is connected to the control valve and the flow channel structure, respectively to introduce the condensed fluid into the flow channel structure for cooling the insert body down.

Thus, through the construction of the embodiments above, the injection forming equipment of the disclosure allows plastic materials in the molten state to be effectively filled in the partial area (e.g., convex columns) of the molding cavity which not only saves costs, but also improves processing time, thereby facilitating producing a plastic product with larger volume and denser vent holes.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The invention can be more fully understood by reading the following detailed description of the embodiment, with reference made to the accompanying drawings as follows.

FIG. 1 is a perspective view of an injection forming equipment according to one embodiment of the present disclosure.

FIG. 2 is a preliminary exploded view of the injection forming equipment of FIG. 1.

FIG. 3 is a cross-sectional view of the injection forming equipment viewed along a line AA of FIG. 1 and a partial enlarged view thereof.

FIG. 4 is an exploded view of the mesh mold core of FIG. 3.

FIG. 5 is a perspective view of the heating plate of FIG. 4 viewed from another perspective.

FIG. 6 is an operative schematic view of the mesh mold core in the embodiment being injected with condensed fluid therein.

FIG. 7 is a cross-sectional view of the injection forming equipment viewed along a line BB of FIG. 4.

FIG. 8 is a cross-sectional view of the injection forming equipment viewed along a line CC of FIG. 4.

FIG. 9 is a cross-sectional view of the injection forming equipment viewed along a line DD of FIG. 4.

FIG. 10 is a detailed schematic view of the condensing module of FIG. 1.

FIG. 11 is a functional block diagram of the injection forming equipment in FIG. 1.

FIG. 12 is a top view of a plastic product with denser vent holes.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

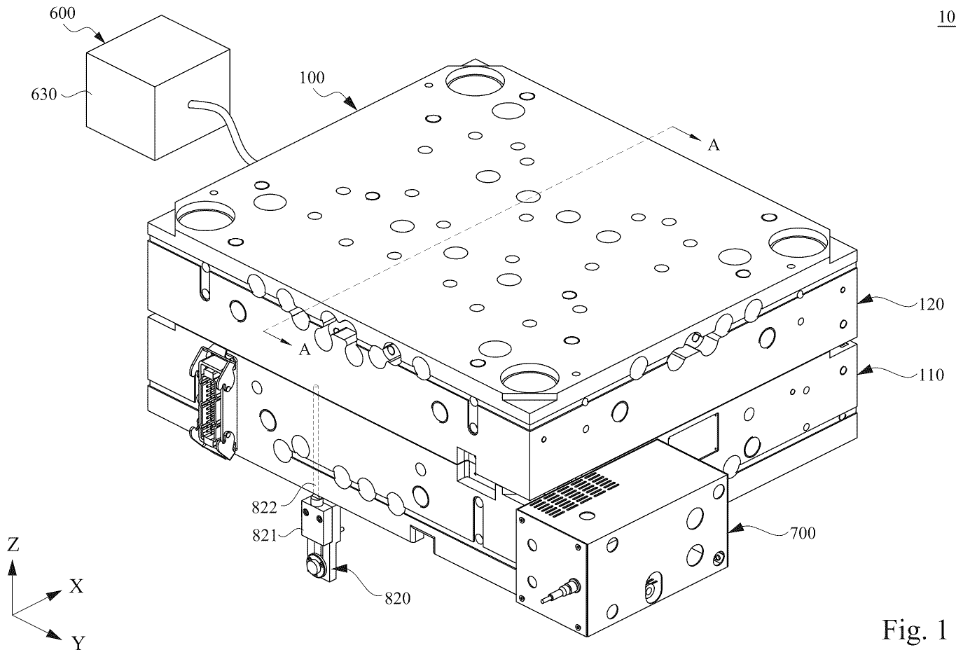

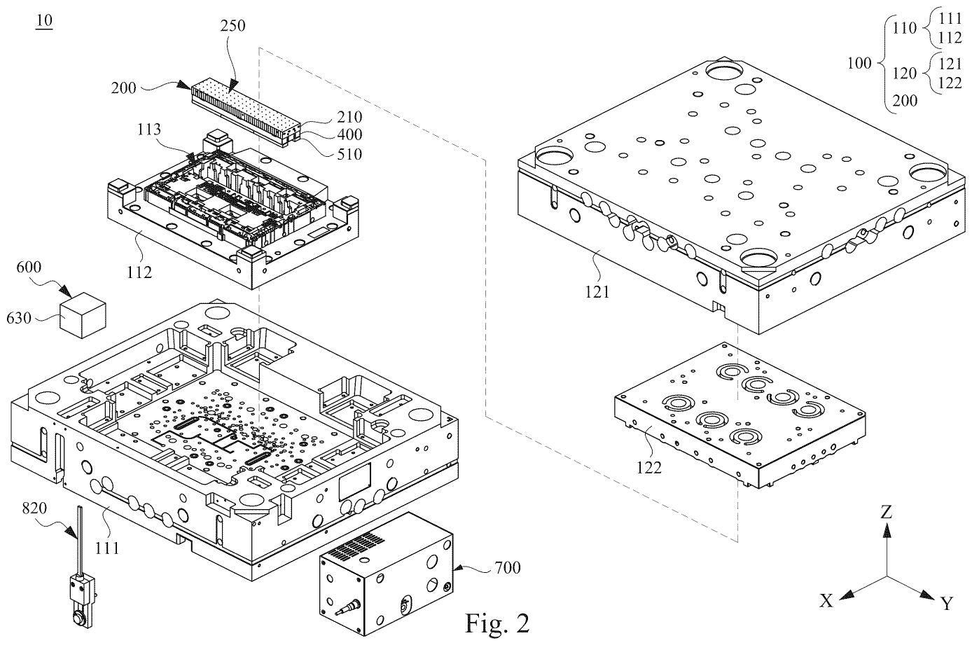

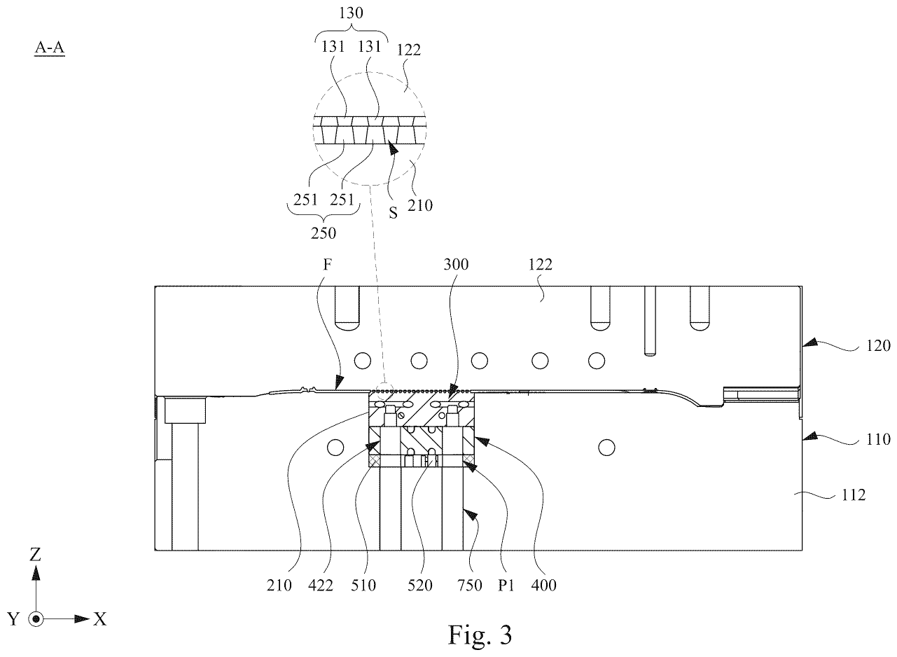

Reference is now made to FIG. 1 to FIG. 3, in which FIG. 1 is a perspective view of an injection forming equipment 10 according to one embodiment of the present disclosure, FIG. 2 is a preliminary exploded view of the injection forming equipment 10 of FIG. 1 and FIG. 3 is a cross-sectional view of the injection forming equipment 10 viewed along a line AA of FIG. 1 and a partial enlarged view thereof. As shown in FIG. 1 to FIG. 3, in the embodiment, the injection forming equipment 10 includes an injection forming mold 100, a heating module 600 and a condensing module 700. The injection forming mold 100 includes a first mold die 110, a second mold die 120 and a mesh mold core 200. The mesh mold core 200 includes an insert body 210, a flow channel structure 300 and a first column-distribution structure 250. The insert body 210 is removably embedded into the first mold die 110. The flow channel structure 300 is formed within the insert body 210. The flow channel structure 300 is formed inside the insert body 210. The first column-distribution structure 250 is formed on one surface of the insert body 210 facing away from the first mold die 110. The second mold die 120 is removably shut the first mold die 110 and the mesh mold core 200 to jointly define a molding cavity F (FIG. 3) therebetween, and the molding cavity F is used to receive high-pressure injected molten material (not shown in figures). One part of the heating module 600 is located within the mesh mold core 200, and another part thereof is located outside the mesh mold core 200 for heating the insert body 210 and the molten material in the molding cavity F. The condensing module 700 is connected to the flow channel structure 300 for filling condensed fluid (e.g., gas or liquid) into the flow channel structure 300 to cool down the insert body 210 and the molten material in the molding cavity F.

More specifically, the first mold die 110 includes a base 111 and a lower mold member 112 that is fixed on the base 111. The lower mold member 112 is recessed with a concave groove 113 at one surface of the lower mold member 112 facing away from the base 111. The size of the concave groove 113 is equivalent to the size of the mesh mold core 200, so that the mesh mold core 200 can be matchingly embedded into the concave groove 113. The second mold die 120 includes a cover 121 and an upper mold member 122 detachably coupled on the cover 121. Thus, when the upper mold member 122 covers the lower mold member 112 and the insert body 210, the aforementioned molding cavity F can be collectively defined by the upper mold member 122, the lower mold member 112 and the insert body 210 (FIG. 3).

In addition, for example, but not limited thereto, as shown in FIG. 3, the first column-distribution structure 250 includes a plurality of first dense convex columns 251 spaced distributed on the insert body 210. More specifically, these first dense convex columns 251 are equidistantly distributed on the surface of the insert body 210, and each of the first dense convex columns 251 integrally protrude from this surface of the insert body 210. The second mold die 120 is provided with a second column-distribution structure 130 having a plurality of second dense convex columns 131 spaced distributed on one surface of the second mold die 120. More specifically, these second dense convex columns 131 are distributed in local positions of the upper mold member 122, and each of the second dense convex columns 131 integrally protrude from an inner surface of the upper mold member 122. Thus, when a part of the upper mold member 122 covers the insert body 210, end surfaces of these first dense convex columns 251 are respectively aligned with and abutted against the end surfaces of these second dense convex columns 131 one by one, and separation spaces S respectively defined by the first dense convex columns 251 and the second dense convex columns 131 are connected with each other, and the separation spaces S become one part of the molding cavity F.

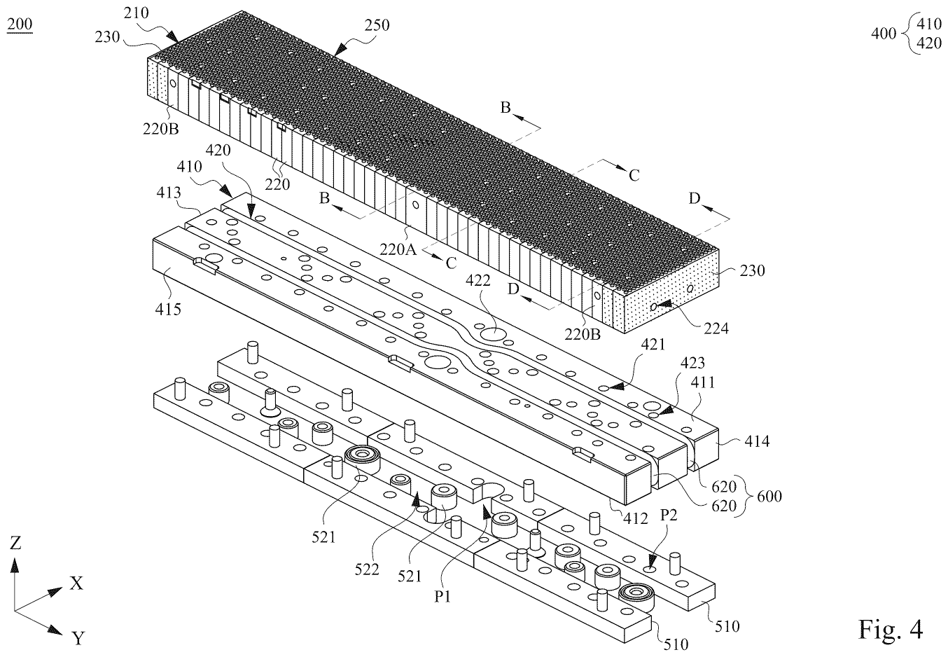

FIG. 4 is an exploded view of the mesh mold core 200 of FIG. 3. as shown in FIG. 3 and, FIG. 4, the mesh mold core 200 further includes a heating plate 400 and a plurality of support blocks 510. The heating plate 400 is fixedly sandwiched between the insert body 210 and the support blocks 510. The support blocks 510 are jointly located on one side of the heating plate 400 facing away from the insert body 210, and each of the support blocks 510 is stacked between the heating plate 400 and the first mold die 110 (e.g., lower mold member 112) for adjusting the height of the insert body 210 in the concave groove 113, the extent to which the first column-distribution structure 250 of the insert body 210 protrudes into the molding cavity F, or the overall thickness of the plastic product.

In the embodiment, for example, the heating plate 400 includes a metal load plate 410 and a plurality (e.g., two) of elongated grooves 420. The metal load plate 410 is stacked on one surface of the insert body 210 facing away from the first column-distribution structure 250, and located within the concave groove 113 of the first mold die 110. These elongated grooves 420 are arranged on the metal load plate 410 abreast. Each of the elongated grooves 420 is recessed on the metal load plate 410.

The heating module 600 includes a plurality (e.g., two) of electric heating pipelines 620 and a power supply unit 630 (FIG. 2). The electric heating pipelines 620 are respectively received within the elongated grooves 420 for directly or indirectly heating the insert body 210. The power supply unit 630 is disposed outside the injection forming mold 100, and electrically connected to the power supply unit 630 for providing electric power. More specifically, in this embodiment, each of the electric heating pipelines 620 is wound around the metal load plate 410, received within one of the elongated grooves 420 along the extending direction of the corresponding elongated groove 420, contacted with the corresponding elongated groove 420, and used to heat the insert body 210 through the metal load plate 410. One end of each of the electric heating pipelines 620 is fixed to one surface of the metal load plate 410 through cup screws B.

It is noted, each of the electric heating pipelines 620 is flexible, for example, can be a copper pipe structure or a copper wire structure. Therefore, the arrangements of the elongated grooves 420 can be made with partial position avoidance adjustment according to the distribution of the flow channel structure 300.

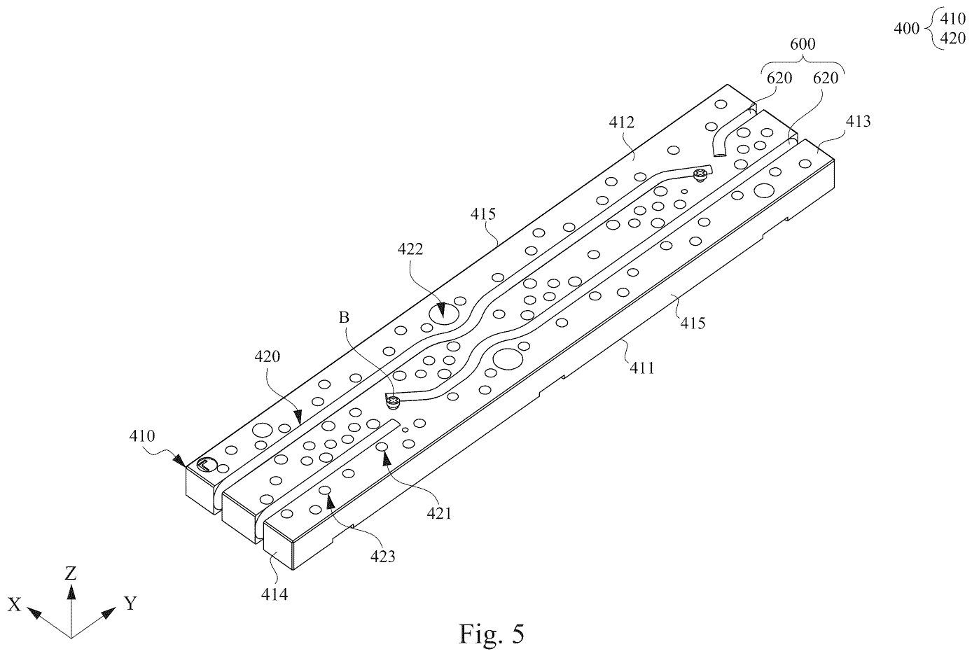

FIG. 5 is a perspective view of the heating plate 400 of FIG. 4 viewed from another perspective. As shown in FIG. 4 and, FIG. 5, the metal load plate 410 is rectangular, includes an upper lateral surface 411, a lower lateral surface 412, a front lateral surface 413, a rear lateral surface 414 and two opposite long lateral surfaces 415. The upper lateral surface 411 and the lower lateral surface 412 are opposite to each other, the upper lateral surface 411 contacts the insert body 210, and the lower lateral surface 412 contacts the support blocks 510. The front lateral surface 413 and the rear lateral surface 414 are opposite to each other, and both face towards the first mold die 110 (e.g., lower mold member 112, FIG. 3) in the concave groove 113, respectively. The front lateral surface 413 is located between the upper lateral surface 411 and the lower lateral surface 412, and the rear lateral surface 414 is located between the upper lateral surface 411 and the lower lateral surface 412. These long lateral surfaces 415 face the first mold die 110 (e.g., lower mold member 112, FIG. 3), respectively in the concave groove 113, and the long axis direction (e.g., Y axis) of each long lateral surfaces 415 is parallel to the long axis direction (e.g., Y axis) of the insert body 210. Each of the elongated grooves 420 continuously spans the upper lateral surface 411 and the lower lateral surface 412, the front lateral surface 413 and rear lateral surface 414 of the metal load plate 410, and is interrupted at the lower lateral surface 412 of the metal load plate 410. Each of the elongated grooves 420 is recessed on the upper lateral surface 411 and the lower lateral surface 412, the front lateral surface 413 and rear lateral surface 414 of the metal load plate 410, the corresponding electric heating pipeline 620 can be bent and received within one of the elongated grooves 420. Each of the electric heating pipelines 620 is made of, for example, copper or other materials with good thermal conductivity. However, the present disclosure is not limited to this type.

Also, as shown in FIG. 4, the metal load plate 410 is further provided with a plurality of first through holes 421. Each of the first through holes 421 penetrates through the metal load plate 410 so as to be connected to the upper lateral surface 411 and the lower lateral surface 412, respectively for the installation of a temperature sensor (not shown) of the heating module 600. For example, each of the first through holes is located between the elongated groove 420 and one of the long lateral surfaces 415, or between the elongated grooves 420. However, the disclosure is not limited thereto. In other embodiments, the position of the first through hole 421 can also be adjusted arbitrarily according to the requirements or restrictions of sensing or installation.

In addition, as shown in FIG. 3 and FIG. 4, the mesh mold core 200 includes one or more partition portions 522. The partition portions 522 are spaced distributed on one surface of the heating plate 400 facing away from the insert body 210 (e.g., lower lateral surface 412 of the metal load plate 410), and arranged between the support blocks 510. Each of the partition portions 522 is sandwiched between the metal load plate 410 and the first mold die 110 (e.g., lower mold member 112, FIG. 3). Therefore, since these partition portions 522 effectively separate the heating plate 400 and the first mold die 110, and an air gap 521 defined between these partition portions 522 and the support blocks 510, thus, most of the heat energy of the heating plate 400 can be conducted to the insert body 210, and the heat energy conducted to the first mold die 110 (e.g., lower mold member 112) can be reduced. The partition portions 522 are made of, for example, titanium alloy or other materials with poor thermal conductivity, however, the disclosure is not limited to this type.

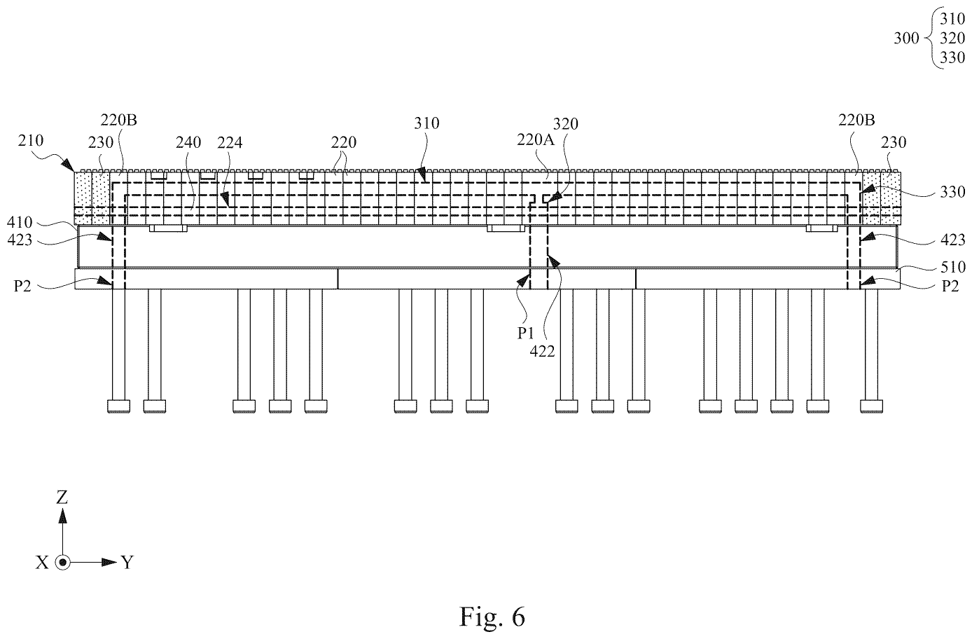

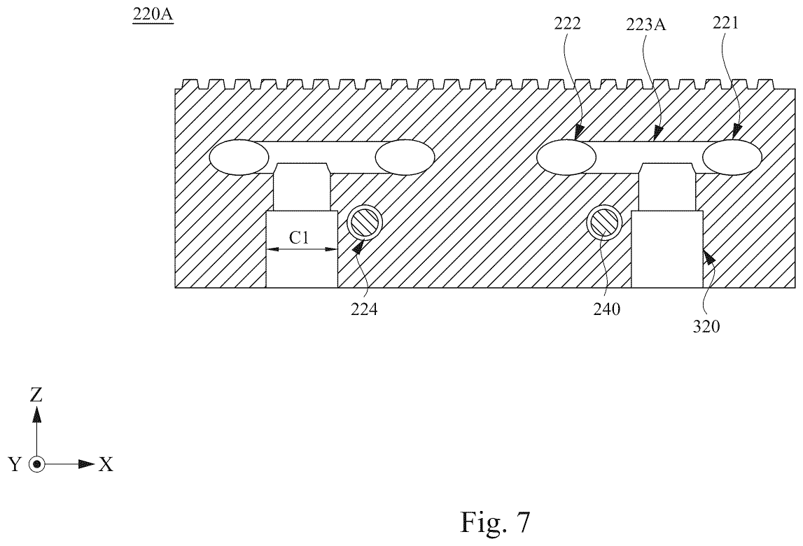

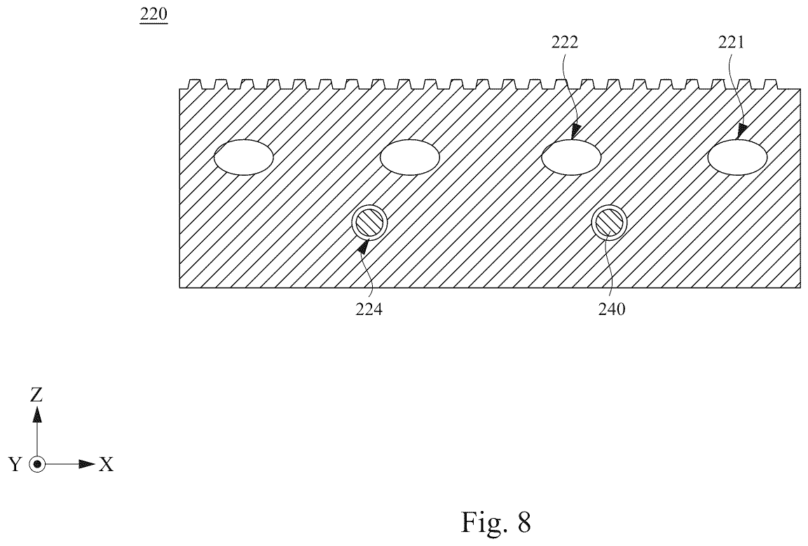

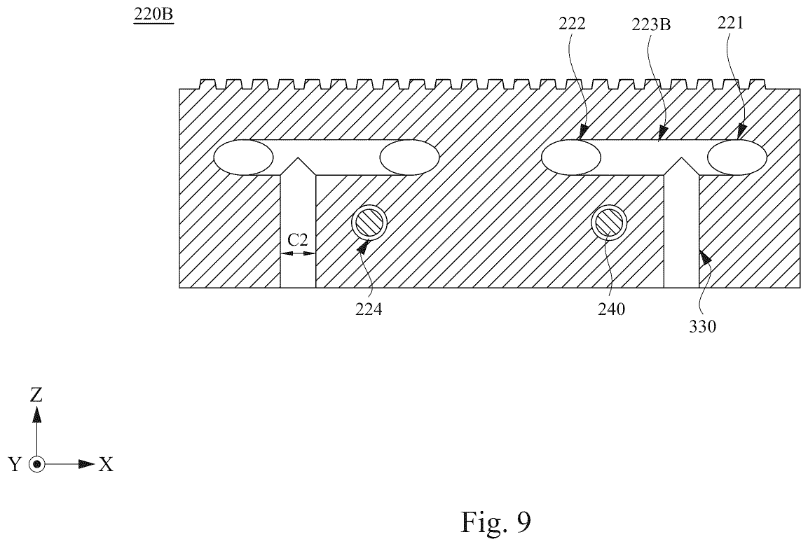

FIG. 6 is an operative schematic view of the mesh mold core 200 in the embodiment being injected with condensed fluid therein. FIG. 7 is a cross-sectional view of the injection forming equipment 10 viewed along a line BB of FIG. 4. FIG. 8 is a cross-sectional view of the injection forming equipment 10 viewed along a line CC of FIG. 4. FIG. 9 is a cross-sectional view of the injection forming equipment 10 viewed along a line DD of FIG. 4.

As shown in FIG. 6, the flow channel structure 300 includes a channel body 310, at least one input channel 320 and at least one output channel 330. The channel body 310 is formed inside the insert body 210, and connected to the input channel 320 and the output channel 330, respectively, for example, the channel body 310 extends along an X-Y axis direction. The input channel 320 and the output channel 330 are both extended downward and connected to the insert body 210 for contacting the surface of the metal load plate 410. The input channel 320 and the output channel 330 are parallel to each other, for example, extending along the Z-axis direction. However, the disclosure is not limited thereto. The input channel 320 is connected to the condensing module 700. The long axis direction of the input channel 320 (e.g., Z axis) is parallel to the long axis direction of the output channel 330 (e.g., Z axis). In this embodiment, the output channels 330 are plural (e.g., 4), and the input channels 320 are plural (e.g., 2), and these input channels 320 are arranged in sequence along the Y-axis and located between these output channels 330, and the diameter C1 of each of the input channels 320 (FIG. 7) is larger than the diameter C2 of each of the output channels 330.

More specifically, in this embodiment, as shown in FIG. 6 and, FIG. 7, the insert body 210 further includes a plurality of first blocks 220, a plurality of second blocks 230 and a plurality of fixed elements 240. The first blocks 220 are stacked sequentially in a stacking direction (e.g., Y axis). Each of the first blocks 220 is formed with at least one first penetrating hole 221 and at least one second penetrating hole 222. The first penetrating holes 221 of the first blocks 220 are collectively and coaxially connected one another, and the second penetrating holes 222 are collectively and coaxially connected one another. In addition, the first penetrating hole 221 and the second penetrating hole 222 in the same one of the first blocks 220 are sequentially arranged along the X axis direction, and arranged at equal heights in this first block 220.

The input channels 320 are only formed in a specific one of the first blocks 220 (referred to a central block 220A hereinafter), and connected to the channel body 310. Each output channel 330 is formed within another one of the first blocks 220 (referred to an outer side block 220B hereinafter), and connected to the channel body 310. The remaining ones of the first blocks 220 are formed without the input channel 320 and the output channel 330. More specifically, the central block 220A is further formed with a connecting groove 223A therein. The connecting groove 223A is only located within the central block 220A to be connected to the first penetrating hole 221, the second penetrating hole 222 and the input channels 320 in the central block 220A. In addition, the first penetrating hole 221, the connecting groove 223A and the second penetrating hole 222 are sequentially communicated together in the X axis direction, and arranged at equal heights in the central block 220A.

As shown in FIG. 6 and, FIG. 9, each of the outer side blocks 220B is further formed with a connecting groove 223B therein. The connecting groove 223B is only located in the outer side block 220B to be connected to the first penetrating hole 221, the second penetrating hole 222 and the output channel 330 in the outer side block 220B. In addition, the first penetrating hole 221, the connecting groove 223B and the second penetrating hole 222 are sequentially connected along the X-axis direction, and arranged at equal heights in the outer side block 220B.

These second blocks 230 are stacked sequentially in the stacking direction (e.g., Y axis), and the first blocks 220 are directly stacked between the second blocks 230. Each of the second blocks 230 is formed without an penetrating hole so that the second blocks can respectively hermetically cover the first one and the last one of the first penetrating holes 221 in the stacking direction and the first one and the last one of the second penetrating holes 222 in the stacking direction. Thus, these first penetrating holes 221, these second penetrating holes 222 and these the connecting groove 223A, 223B which are in communication together are collectively formed the aforementioned channel body 310, and the fixed elements 240 fixedly assemble the first blocks 220 and the second blocks 230 together, thereby assembling the above-mentioned flow channel structure 300. For example, the first blocks 220 and the second blocks 230 respectively have screw holes 224 which are coaxial with each other, and these fixing elements 240 are, for example, bolts, which pass through the screw holes 224 of the first blocks 220 and the second blocks 230 in sequence along the Y-axis direction, so that the first blocks 220 and the second blocks 230 can be tightly stacked together.

However, the disclosure is not limited thereto. In other embodiments, the second penetrating hole 222 or/and the connecting grooves 223A, 223B formed in the first block 220 can also be omitted so that the scale of the flow channel structure 300 can also be changed accordingly; the input channel 320 can also be changed to be in communication with the first penetrating hole 221 or the second penetrating hole 222 in the central block 220A; or the output channel 330 can also be changed to be in communication with the first penetrating hole 221 or the second penetrating hole 222 in the outer side block 220B.

More specifically, as shown in FIG. 4 and FIG. 6, the metal load plate 410 is further provided with a plurality of second through holes 422 and a plurality of third through holes 423. Each of the second through holes 422 penetrates through the metal load plate 410 so as to be connected to the upper lateral surface 411 and the lower lateral surface 412, respectively. Each of the second through holes 422 is coaxially aligned with the input channel 320 of the flow channel structure 300, wherein each of the second through holes 422 is respectively connected to the input channel 320 and a corresponding through hole P1 of one of the support blocks 510 (FIG. 3). Each of the third through holes 423 penetrates through the metal load plate 410 so as to be connected to the upper lateral surface 411 and the lower side 412, respectively. Each of the third through holes 423 is coaxially aligned with the output channel 330 of the flow channel structure 300, wherein one end of each of the third through holes 423 is connected to the output channel 330, the other end thereof is connected to an exhaust measure (not shown in figures) of the first mold die 110 through a corresponding through hole P2 of the support block 510.

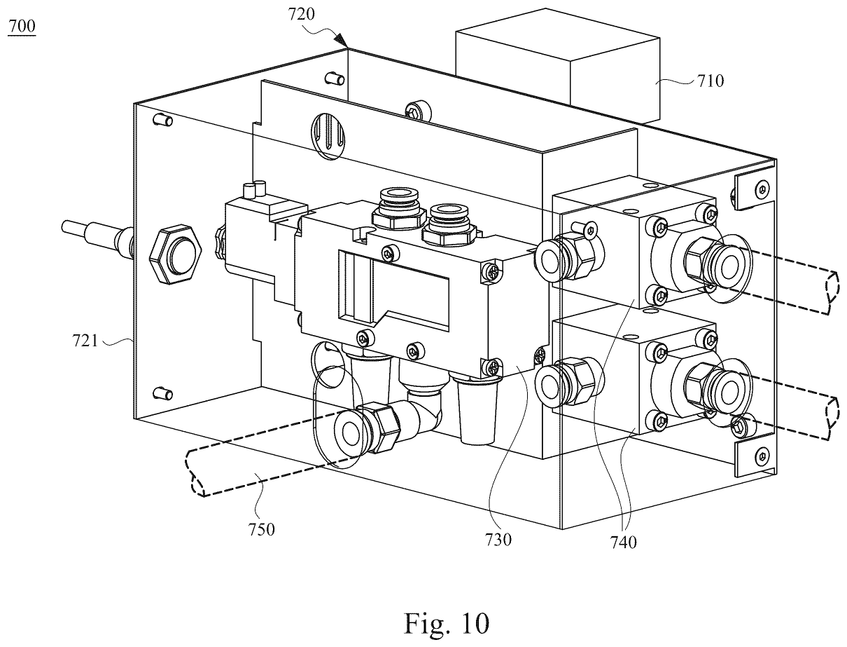

FIG. 10 is a detailed schematic view of the condensing module 700 of FIG. 1. As shown in FIG. 10, the condensing module 700 includes an air compressor 710, a condenser 720 and a plurality (e.g., two) air supply pipes 750. One end of each of the air supply pipes 750 is connected to the condenser 720, and the other end thereof is connected to one of the input channels 320. In this embodiment, the other end of the air supply pipe 750 passes through the first mold die 110, the heating plate 400 and one of the support blocks 510 in sequence, and extends into the input channel 320 (FIG. 3). The air compressor 710 is located outside the injection forming mold 100 for delivering normal temperature air to condenser 720. The condenser 720 is located outside the injection forming mold 100 for converting normal temperature air into condensed fluid and injecting the condensed fluid into the flow channel structure 300 through the air supply pipe 750.

For example, in this embodiment, the condenser 720 includes a case 721, a control valve 730, a plurality (e.g., two) of vortex tubes 740. The vortex tube 740 are disposed within the case 721 for spraying condensed fluid for receiving normal temperature air from the air compressor 710 and producing condensed fluid. The control valve 730 is located in the case 721. One end of the control valve 730 is collectively connected to these vortex tubes 740 through, for example, a three-way air pipe (not shown in figures), the other end thereof is connected to one of the input channels 320 through one of the air supply pipes 750. The control valve 730 is, for example, a solenoid valve or alike, for controlling the timing of the condensed fluid of each of the vortex tubes 740 being sent into the flow channel structure 300. Each of the air supply pipes 750 is connected to the control valve 730 and the flow channel structure 300, respectively for introducing the condensed fluid into the flow channel structure 300 and cooling the insert body 210 down.

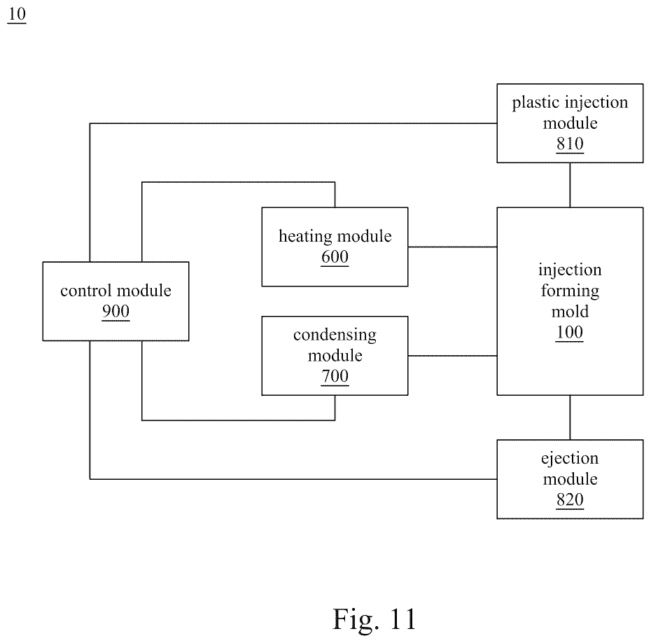

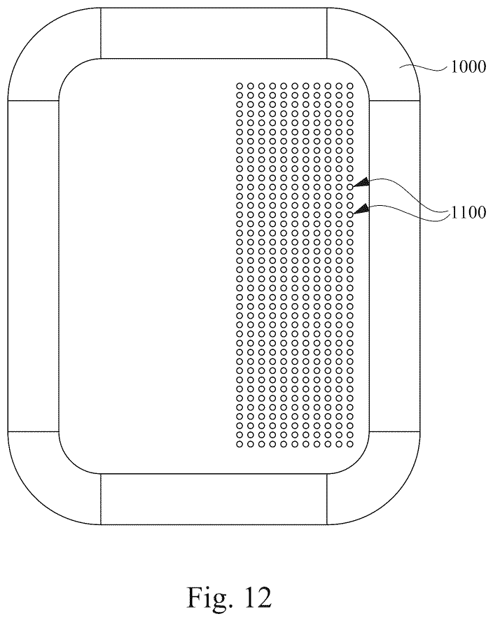

FIG. 11 is a functional block diagram of the injection forming equipment 10 in FIG. 1. FIG. 12 is a top view of a plastic product 1000 with denser vent holes 1100. As shown in FIG. 1 and FIG. 11, the injection forming equipment 10 further includes a control module 900, a plastic injection module 810 and an ejection module 820. The plastic injection module 810 is connected to the second mold die 120 for injecting molten plastic material into the molding cavity F (FIG. 3) through the second mold die 120. The ejection module 820 includes a transmission unit 821 and a mold ejection pin 822 (as shown in FIG. 1). The mold ejection pin 822 is movably located on the first mold die 110, and used to push the plastic product 1000 (as shown in FIG. 12) in the molding cavity F (FIG. 3) outwards from the second mold die 120. The transmission unit 821 is used to drive the mold ejection pin 822 to extend and withdraw. The control module 900 is electrically connected to the plastic injection module 810, the ejection module 820, the heating module 600 and the condensing module 700, and used to appropriately control the plastic injection module 810, the ejection module 820, the heating module 600 and the condensing module 700 to operate in sequence according to working procedures. The control module 900 is, for example, a hardware device such as a CPU or a computer controlling device.

For example, as shown in FIG. 2 and FIG. 11, the control module 900 performs the following steps according to the aforementioned working procedures. In step 1, the heating module 600 is operated to heat the insert body 210 to about 80° C. In step 2, the first mold die 110 and the second mold die 120 are closed together, and after mold closing, delay for example 3 seconds to stop heating the insert body 210. In step 3, the molten plastic material is injected into the molding cavity F by the plastic injection module 810. In step 4, the plastic injection pressure is controlled to cooperate with the pressure maintaining action by the plastic injection module 810. In step 5, the insert body 210 is cooled down to about 65° C. by the condensing module 700, so that the molten plastic material in the molding cavity F quickly form a plastic product 1000 (as shown in FIG. 12). In step 6, the first mold die 110 and the second mold die 120 are opened apart, and after mold opening, delay for example 5 seconds to start heating the insert body 210. In step 7, the ejection module 820 is operated to eject the plastic product 1000 (as shown in FIG. 12), and the mold ejection pin 822 is withdrawn back, finally, go back to step 1 for completing a molding cycle which takes approximately 40 seconds.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An injection forming equipment, comprising:
an injection forming mold comprising a first mold die, a second mold die and a mesh mold core, the second mold die that is removably shut the first mold die and the mesh mold core to jointly define a molding cavity therebetween, the mesh mold core comprising an insert body that is removably mounted on the first mold die, a flow channel structure that is formed in the insert body, and a column-distribution structure that is located on one surface of the insert body;
a heating module located within the mesh mold core, for heating the insert body; and
a condensing module connected to the flow channel structure to introduce condensed fluid into the flow channel structure for cooling the insert body down.

2. The injection forming equipment of claim 1, wherein the flow channel structure comprises a channel body, at least one input channel and at least one output channel, the at least one input channel is connected to the condensing module, and the channel body is formed in the insert body, and connected to the at least one input channel and the at least one output channel, respectively.

3. The injection forming equipment of claim 2, wherein the insert body comprises:
a plurality of first blocks stacked sequentially in a stacking direction, wherein each of the first blocks is formed with a first penetrating hole, and the first penetrating holes of the first blocks are coaxially connected to one another;
a plurality of second blocks stacked sequentially in the stacking direction, wherein the first blocks are directly stacked between the second blocks, and the second blocks respectively hermetically cover a first one and a last one of the first penetrating holes in the stacking direction so that the first penetrating holes in communication with each other are together formed the channel body; and
at least one fixed element fixing the first blocks and the second blocks.

4. The injection forming equipment of claim 3, wherein each of the first blocks is further formed with a second penetrating hole, and the second penetrating holes of the first blocks are coaxially connected to one another, and the second blocks respectively hermetically cover a first one and a last one of the second penetrating holes in the stacking direction so that all of the first penetrating holes and the second penetrating holes which are in communication with each other are together formed the channel body.

5. The injection forming equipment of claim 2, wherein the at least one output channel includes plural output channels, and the at least one input channel is disposed between the output channels, and a diameter of the at least one input channel is larger than a diameter of each of the output channels.

6. The injection forming equipment of claim 2, wherein the condensing module comprises a condenser and at least one air supply pipe connected to the condenser and the at least one input channel, respectively.

7. The injection forming equipment of claim 1, wherein the mesh mold core further comprises:
a metal load plate stacked on one surface of the insert body facing away from the column-distribution structure, and located within the first mold die; and
at least one elongated groove recessed on the metal load plate; and
the heating module comprises at least one electric heating pipeline received within the at least one elongated groove along an extending direction of the at least one elongated groove and contacted with the metal load plate for heating the insert body through the metal load plate.

8. The injection forming equipment of claim 7, wherein the mesh mold core further comprises:
a plurality of support blocks jointly located on one surface of the metal load plate facing away from the insert body, and stacked between the metal load plate and the first mold die; and
at least one partition portion located on the surface of the metal load plate facing away from the insert body, arranged between the support blocks, and sandwiched between the metal load plate and the first mold die.

9. The injection forming equipment of claim 8, wherein the at least one elongated groove comprises a plurality of elongated grooves located between the support blocks; and
the at least one electric heating pipeline comprises a plurality electric heating pipelines respectively received within the elongated grooves, and the at least one partition portion is located between the electric heating pipelines.

10. The injection forming equipment of claim 1, wherein the column-distribution structure comprises a plurality of first dense convex columns spaced distributed on the surface of the insert body; and
the second mold die is provided with another column-distribution structure having a plurality of second dense convex columns spaced distributed on one surface of the second mold die,
wherein when the second mold die covers the mesh mold core, the first dense convex columns are respectively aligned with and abutted against the second dense convex columns in the molding cavity.

11. An injection forming equipment, comprising:
an injection forming mold comprising a first mold die, a second mold die and a mesh mold core, the second mold die that is removably shut the first mold die and the mesh mold core to jointly define a molding cavity therebetween, the mesh mold core comprising an insert body that is removably mounted on the first mold die, a flow channel structure that is formed in the insert body, and a column-distribution structure that is located on one surface of the insert body;
a heating module located within the mesh mold core for heating the insert body; and
a condensing module comprising a case, a control valve, at least one vortex tube and at least one air supply pipe, the at least one vortex tube that is disposed within the case for spraying condensed fluid, the control valve that is located in the case and connected to the at least one vortex tube for controlling a timing of the condensed fluid of the vortex tube being sent into the flow channel structure, and the at least one air supply pipe connected to the control valve and the flow channel structure, respectively for introducing the condensed fluid into the flow channel structure and cooling the insert body down.

12. The injection forming equipment of claim 11, wherein the flow channel structure comprises a channel body, at least one input channel and at least one output channel, the at least one input channel is connected to the condensing module, and the channel body is formed in the insert body, and connected to the at least one input channel and the at least one output channel, respectively.

13. The injection forming equipment of claim 12, wherein the insert body comprises:
a plurality of first blocks stacked sequentially in a stacking direction, wherein each of the first blocks is formed with a first penetrating hole, and the first penetrating holes of the first blocks are coaxially connected to one another;
a plurality of second blocks stacked sequentially in the stacking direction, wherein the first blocks are directly stacked between the second blocks, and the second blocks respectively hermetically cover a first one and a last one of the first penetrating holes in the stacking direction so that the first penetrating holes in communication with each other are together formed the channel body; and
at least one fixed element fixing the first blocks and the second blocks.

14. The injection forming equipment of claim 13, wherein each of the first blocks is further formed with a second penetrating hole, and the second penetrating holes of the first blocks are coaxially connected to one another, and the second blocks respectively hermetically cover a first one and a last one of the second penetrating holes in the stacking direction so that the first penetrating holes and the second penetrating holes which are in communication with each other are together formed the channel body.

15. The injection forming equipment of claim 12, wherein the at least one output channel includes plural output channels, and the at least one input channel is disposed between the output channels, and a diameter of the at least one input channel is larger than a diameter of each of the output channels.

16. The injection forming equipment of claim 11, wherein the mesh mold core further comprises:
a metal load plate stacked on one surface of the insert body facing away from the column-distribution structure, and located within the first mold die; and
at least one elongated groove recessed on the metal load plate; and
the heating module comprises at least one electric heating pipeline received within the at least one elongated groove along an extending direction of the at least one elongated groove and contacted with the metal load plate for heating the insert body through the metal load plate.

17. The injection forming equipment of claim 16, wherein the mesh mold core further comprises:
a plurality of support blocks jointly located on one surface of the metal load plate facing away from the insert body, and stacked between the metal load plate and the first mold die; and
at least one partition portion located on the surface of the metal load plate facing away from the insert body, arranged between the support blocks, and sandwiched between the metal load plate and the first mold die.

18. The injection forming equipment of claim 17, wherein the at least one elongated groove comprises a plurality of elongated grooves located between the support blocks; and
the at least one electric heating pipeline comprises a plurality electric heating pipelines respectively received within the elongated grooves, and the at least one partition portion is located between the electric heating pipelines.

19. The injection forming equipment of claim 11, wherein the column-distribution structure comprises a plurality of first dense convex columns spaced distributed on the surface of the insert body; and
the second mold die is provided with another column-distribution structure having a plurality of second dense convex columns spaced distributed on one surface of the second mold die,
wherein when the second mold die covers the mesh mold core, the first dense convex columns are respectively aligned with and abutted against the second dense convex columns in the molding cavity.
